(19) United States
(12) Patent Application Publication
(10) Pub. No.: US 2006/0008341 A1
(43) Pub. Date: Jan. 12, 2006

(54) Method for collecting, distributing, and viewing inspection reports for lifting devices

(75) Inventors: Tony Mazzella, Olmsted Falls, OH (US); Mark D'Aliberti, Olmsted Falls, OH (US); Ron Cerny, North Olmsted, OH (US); Slav Kozyuk, Westlake, OH (US)

Correspondence Address: BROUSE MCDOWELL LPA, 388 SOUTH MAIN STREET, SUITE 500, AKRON, OH, 44311, US

(73) Assignee: Mazzella Lifting Technologies

(21) Appl. No.: 10/615,359

(22) Filed: Jul. 8, 2003

Related U.S. Application Data
(60) Provisional application No. 60/394,857, filed on Jul. 10, 2002.

(51) Int. Cl. B25J 1/00

(52) U.S. Cl. 414/1

(57) ABSTRACT

A method for viewing inspection report data from the inspection of a lifting device, such as lifting straps, lifting chains and the like is described that transfers report data to a host computer that is connected to the Internet. A user of the lifting devices may log onto the host the computer to view the inspection report or print the inspection reports as desired.

This application claims priority from a U.S. Provisional patent application, Ser. No. 60/394,857, filed Jul. 10, 2002.

1. Background of the Invention

A. Field of Invention

This invention pertains to the art of methods for viewing the inspection reports for a lifting device, and more specifically to a lifting strap or lifting chain.

B. Description of the Related Art

It is known in the art to periodically inspect lifting devices for safety purposes. Such lifting devices may include chains or lifting straps used to lift and move heavy equipment. The lifting devices may be operatively connected to an overhead crane or other load-carrying device. During normal use, the lifting devices may be damaged. Chains may rust or may be tarnished with weld splatter. Straps may fray, tear, or be exposed to deteriorating chemicals such as acids. Typically, an inspector, who may be an individual trained in safety inspection, would look over the lifting device to check for indications that the device may not currently be capable of lifting its rated load. Such inspections may include the use of a machine to actually test the load carrying capacity of a lifting device.

After the inspection has been completed, a report is generated that may list the current condition of the lifting device, information identifying the specific device, and other information such as the date and time of the inspection. This report is then delivered to the company or user of the lifting device, or it may be stored at the company that performed the inspection. Certain safety programs and/or organizations require the periodic inspection of the lifting device's straps before utilizing them to lift a piece of equipment or other load. As it may be necessary to show the report(s) during a company wide safety inspection, these reports should be available for review upon demand. However, reports are frequently lost or may not be viewable from a central location.

The present invention provides methods for storing and viewing inspection reports over the Internet from a plurality of locations. The reports may be sorted as desired and printed out with authorization from any location.

### II. SUMMARY OF THE INVENTION

According to one aspect of the present invention, a method of viewing inspection reports for lifting devices is provided, which utilizes the Internet for access to authorized users.

Another aspect of the present invention is that the inspection reports may be generated electronically and stored in a database on a central computer.

Yet another aspect of the present invention is that the inspection reports may be sorted by inspection date, type, or location.

Yet another aspect of the present invention includes a method for viewing inspection reports for an associated lifting device, the steps comprising:
providing an associated lifting device being operated by an associated user-entity;
providing an associated periodic inspection by an associated qualified inspector;
providing at least a first inspection report generated in response to the associated inspection;
providing a computer operatively communicated to an associated computer network;
operatively storing at least a first portion of the at least a first inspection report on the computer, wherein the at least a first portion of the at least a first inspection report is viewable over the associated computer network; and,
implementing a security means on the computer for use in selectively allowing the associated user-entity to view the at least a first portion of at least a first inspection report over the associated computer network.

Yet another aspect of the present invention includes a method wherein the step of providing an associated lifting device being operated by an associated user-entity:
providing an associated lifting strap being operated by an associated user-entity.

Yet another aspect of the present invention includes a method wherein the step of providing an associated lifting device being operated by an associated user-entity:
providing an associated lifting chain being operated by an associated user-entity.

Yet another aspect of the present invention includes a method wherein the step of operatively storing at least a first portion of the at least a first inspection report on the computer includes:
operatively storing an inventory list of the at least a first portion of the at least a first inspection report on the computer, wherein the inventory list is viewable over the computer network.

Yet another aspect of the present invention includes a method wherein the step of operatively storing at least a first portion of the at least a first inspection report on the computer includes:
operatively storing a summary list of the at least a first portion of the at least a first inspection report on the computer, wherein the summary list is viewable over the computer network.

Yet another aspect of the present invention includes a method wherein the step of operatively storing at least a first portion of the at least a first inspection report on the computer, includes:
storing at least a first portion of the at least a first inspection report in a database, wherein the database is operatively accessible by the computer.

Yet another aspect of the present invention includes a method wherein the step of storing at least a first portion of the at least a first inspection report in a database, wherein the database is operatively accessible by the computer, includes:
storing at least a first portion of the at least a first inspection report in a database, wherein the database is operatively stored on the computer.

Yet another aspect of the present invention includes a method wherein after the step of storing at least a first portion of the at least a first inspection report in a database, wherein the database is operatively accessible by the computer, the step further comprising:
selectively sorting the database, wherein the sorted at least a first portion of the at least a first inspection report is selectively viewable over the computer network.

Yet another aspect of the present invention includes a method wherein the step of providing at least a first inspection report generated in response to the associated inspection, includes:
providing a plurality inspection reports generated in response to a plurality of associated inspections, and;
wherein the step of selectively sorting the database, includes:
selectively sorting the database with respect to the history of the plurality of inspection reports, wherein the sorted at least a first portion of the plurality of inspection reports is selectively viewable over the computer network.

Yet another aspect of the present invention includes a method for periodically testing and viewing the testing report for an associated lifting strap, the steps comprising:
providing an associated lifting strap testing device for testing the lifting capacity of the associated lifting strap, the associated testing device including associated software for use in processing the test information;
providing a testing person qualified to operate the associated testing device;
performing the lifting capacity test on the associated lifting strap;
generating a test report responsive to an output from the associated testing device;
providing a computer operatively communicated to an associated computer network; and,
storing at least a first portion of the electronic test report on the computer, wherein the at least a first portion of the test report is viewable over the associated computer network.

Yet another aspect of the present invention includes a method wherein the step of generating a test report responsive to an output from the associated testing device, includes:
generating an electronic test report responsive to an output from the associated testing device.

Yet another aspect of the present invention includes a method of tracking the testing history for a plurality of associated lifting devices, the steps comprising:
providing a plurality of associated lifting devices for use by an associated user-entity;
periodically individually testing the plurality of associated lifting devices;
generating a testing report responsive to each individual test;
providing a computer operatively communicated to an associated computer network; and,
storing the testing reports on the computer, wherein the plurality of testing reports are selectively viewable by the user-entity.

Yet another aspect of the present invention includes a method wherein the step of providing a plurality of associated lifting devices includes:
providing a plurality of associated lifting straps for use by an associated user-entity.

Yet another aspect of the present invention includes a method wherein the step of periodically individually testing the plurality of associated lifting devices, includes:
periodically testing the current lifting capacity of the plurality of associated lifting devices.

Yet another aspect of the present invention includes a method wherein before the step of periodically testing the current lifting capacity of the plurality of associated lifting devices, the step further comprising:
providing an associated lifting capacity testing apparatus having associated software that electronically stores testing information responsive to the testing.

Yet another aspect of the present invention includes a method wherein the step of providing a computer operatively communicated to an associated computer network, includes:
providing a microprocessor-based computer operatively communicated to the internet.

Yet another aspect of the present invention includes a method the step further comprising:
sorting the testing reports with respect to the testing date.

The present invention provides a method for viewing the inspection reports of one or more lifting devices. The lifting devices may include but are not limited to: lifting straps, lifting chains, mesh straps, tie down straps and the like. An inspector is provided to review and inspect the lifting devices. Alternately, the inspector may test the lifting capacity of the lifting devices with the use of a testing machine. The inspector may be trained in the art of inspecting lifting devices.

Once the inspection has been completed, the inspection data may be transferred to a host computer or other microprocessing unit for use in selectively displaying the test data to the user or owner of the lifting devices. The transfer of data may encompass the electronic transfer of data or the manual transfer of data into the host computer. The host computer may be communicated to a network allowing the user or owner remote access to the inspection data via the network. The network may be the Internet.

The user or owner, who requires remote access to the inspection data, may be required to log onto the system with a predetermined password. Upon verification of proper identity, the user or owner may maneuver through the display screens to sort and display the data from one of the preformatted display screen. The user may also transfer report data electronically, via the network, to his server computer or print the inspection data as desired.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one preferred embodiment of which will be described in detail in this specification and illustrated in the accompanying drawings which form a part hereof and wherein:

FIG. 1 is a side view of lifting devices and more specifically lifting chains.

FIG. 2 is a side view of lifting devices and more specifically lifting straps.

FIG. 3 is a side view of lifting devices and more specifically mesh straps.

FIG. 4 is a schematic representation of multiple user-entity sites having a plurality of lifting devices.

FIG. 5 is a schematic representation of a user of a lifting device lifting and moving an object.

FIG. 6 is a schematic representation of an inspector traveling to a user-entity site to inspect the lifting devices at that site.

FIG. 7 is a schematic representation of an inspection report.

FIG. 8 is a schematic representation of an inspection report.

FIG. 9 is a schematic representation of a load-testing device.

FIG. 10 is a schematic representation of a load test report generated by load testing device.

FIG. 11 is a view of a host microprocessing unit connected to a network, and more specifically connected to the Internet.

FIG. 12 is a schematic representation of an inventory display list.

FIG. 13 is a schematic representation of an inspection report display list.

FIG. 14 is a schematic representation of a summary report display list.

FIG. 15 is a schematic representation of a home display screen.

### IV. DESCRIPTION OF THE INVENTION

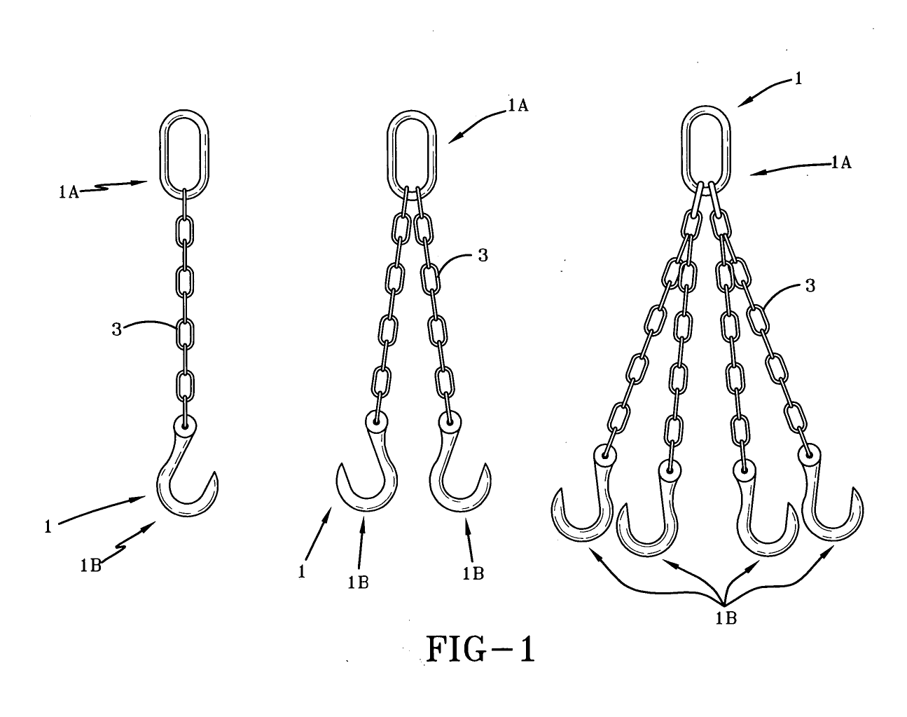

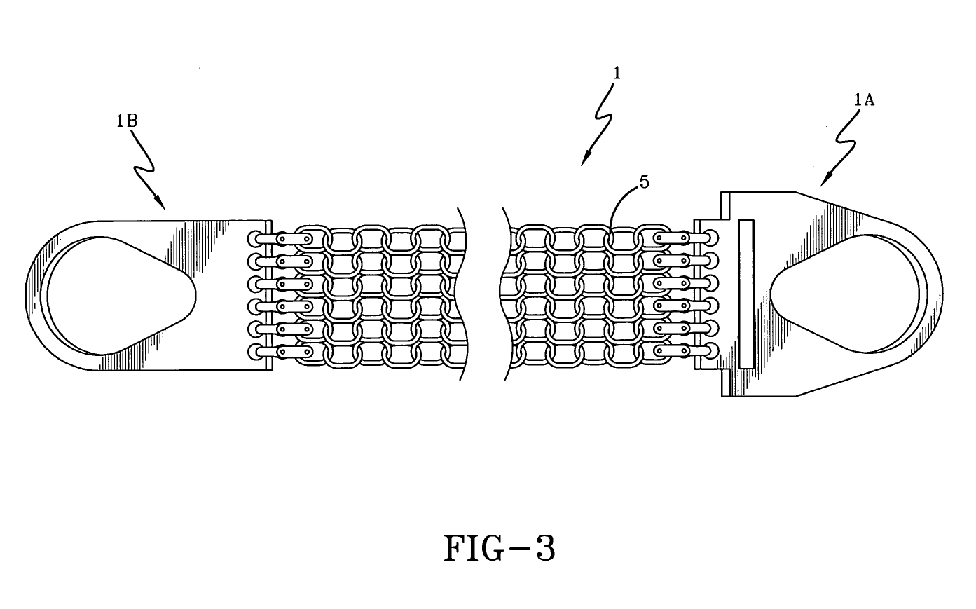

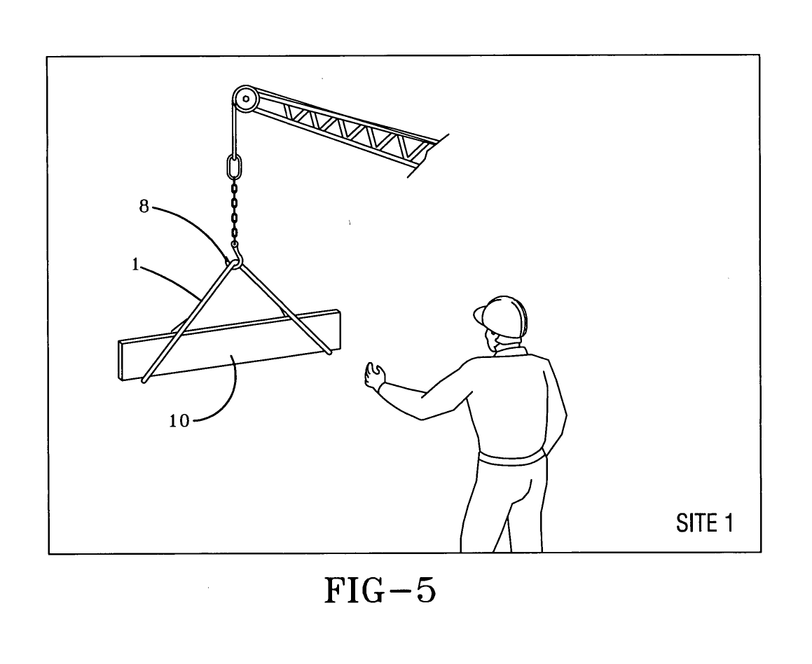

Referring now to the drawings wherein the showings are for purposes of illustrating at least one embodiment of the invention only and not for purposes of limiting the same, FIGS. 1 through 3 depict a plurality of lifting devices shown generally at 1. The lifting devices 1 may be a lifting chain 3, a lifting strap 4, a mesh sling 5, hoists, tie down straps, not shown, and the like. However, the lifting device 1 of the present inventive method may be any device operable and intended for use in supporting heavy objects that may be lifted with a crane or other such apparatus, including a crane. The lifting device 1 may be constructed from any material appropriate for use with lifting a predetermined load. This material may include, but is not limited to, nylon or other synthetic material, steel or iron alloy, chain link, etc. In this way, the lifting chain 3 may be constructed from steel links 3a. Similarly, the lifting strap 4 may be constructed from woven nylon. In that the assembly and use of lifting devices 1 is well known, no further explanation will be offered at this time. The lifting device 1 may include a first end 1 a that may be inserted onto or over a crane hook 8, shown in FIG. 5, in a manner well known in the art. It is noted that devices other than cranes may be used to lift and move an object, such as moveable A-frames with manual or power-driven lifting mechanisms. A second end 1b of the lifting device 1 may be received by a lifting member, not shown, fixedly attached to an object to be lifted. One example of the lifting member may include an eyebolt operatively connected to the object being lifted. The lifting device 1 may be safely wrapped around the object to be lifted or fed through the lifting member for use in securely lifting and transporting the object as desired. In other words, the second end 1b of the lifting device 1 may be directly hooked onto the lifting member of the object or may be inserted through the lifting member and subsequently hooked or inserted back over the crane hook 8. In that the use and set up of lifting devices 1 for carrying and transporting heavy objects is well known in the art, no further explanation will be offered at this time.

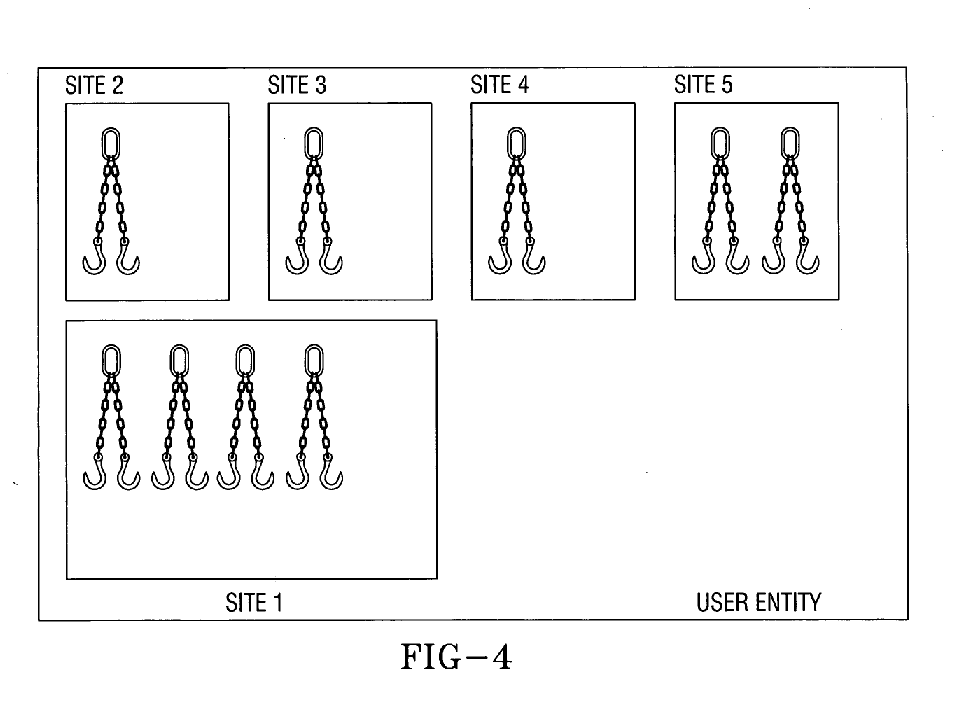

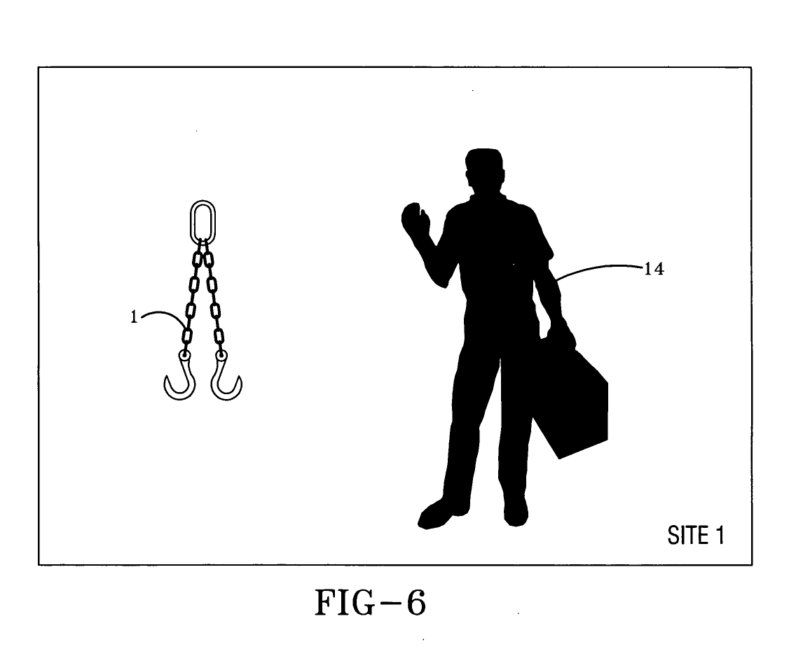

With reference now to FIGS. 4 through 6, a plurality of lifting devices 1 may be purchased for use at one or more company locations or company sites, depicted in FIG. 4. A company, person or any user-entity may purchase the lifting devices 1 depending on the current need at that particular site. The lifting devices 1 may be stored in a central location at the site or may be stored at a several locations within the site and checked out for use as needed. The company or user-entity may possess overhead cranes, or other similar apparatus, for use with the lifting devices 1. In other words, a company having a first company site may own several lifting chains and/or lifting straps, which may be used in conjunction with cranes, installed at the site for use in lifting heavy objects as desired. In this embodiment, an inspector 14 may inspect the condition of the lifting devices 1, as depicted in FIG. 6. The inspector 14 may be an outside inspector 14 not directly employed by the user-entity or company. The outside inspector 14 may travel to the customer site and perform the inspection and/or a test as will be discussed in a subsequent paragraph. Alternately, the inspector 14 may be an employee of the user-entity or the direct user of the lifting device 1. The inspector 14 may be qualified to inspect the lifting devices 1. That is to say, the inspector 14 may have been trained to review and inspect lifting devices 1 in a manner well known in the art. However, it is also contemplated that the inspector 14 may not be trained but may still be qualified to inspect lifting devices 1 having only used the lifting devices 1 in various lifting scenarios. In other words, the inspector 14 may be qualified by having years of experience using the lifting device. The inspector 14 may inspect and review the lifting devices 1 at one or more sites (reference FIG. 4). In this manner, the inspector 14 may inspect all of the lifting devices 1 that a company or user-entity may own and use. The inspection process may therefore account or keep track of the condition and whereabouts of all lifting devices 1 within a company.

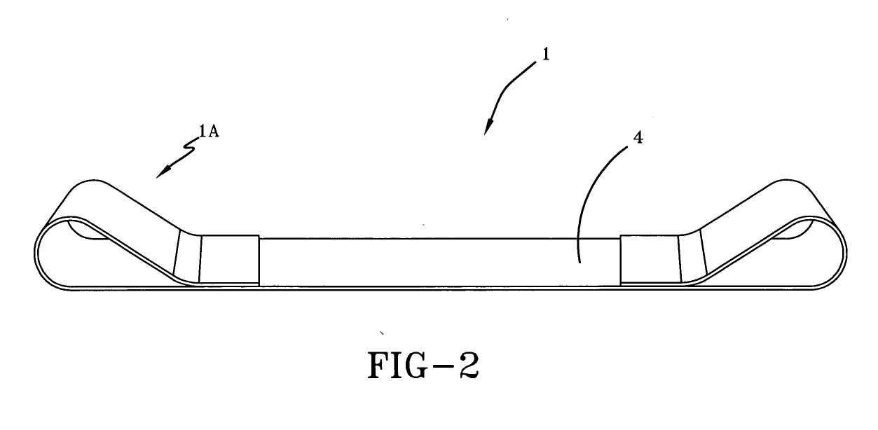

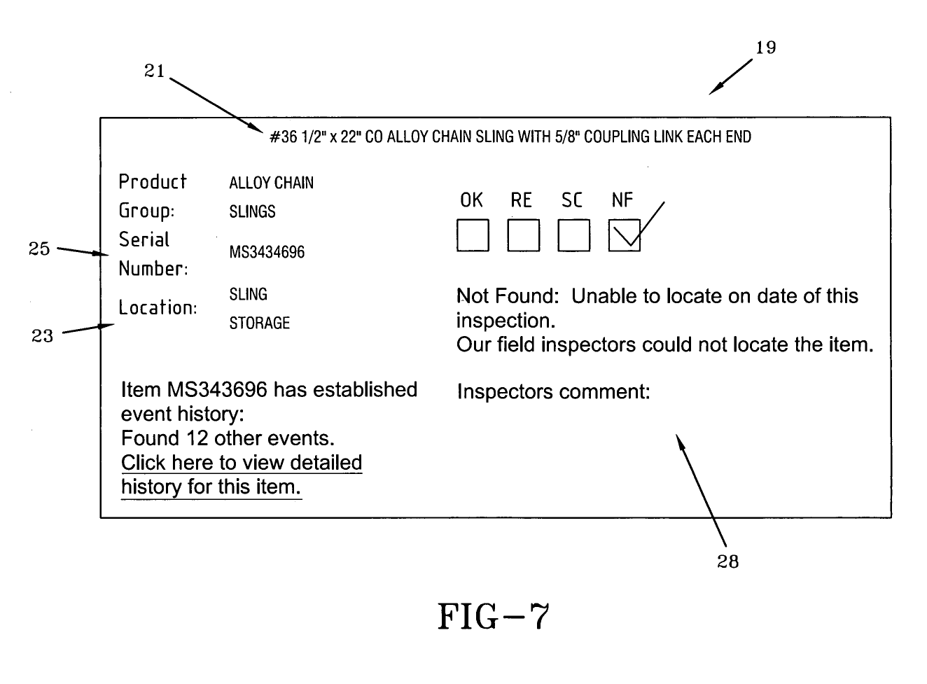

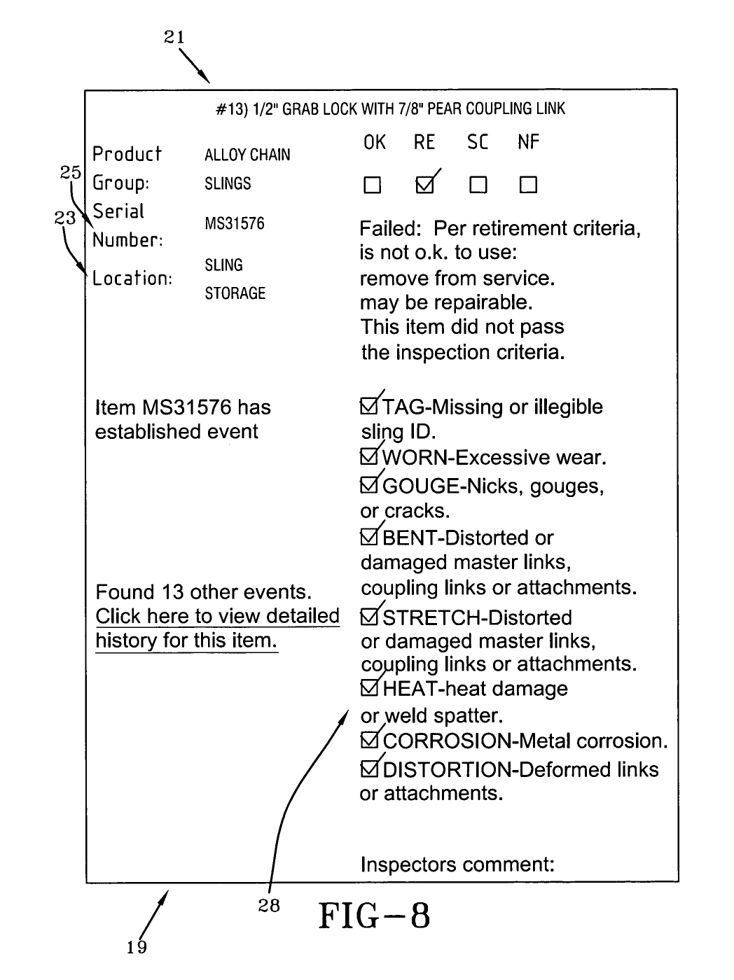

With continued reference to FIGS. 4 through 6 and now to FIGS. 7 and 8, the inspector 14 may travel to various sites at which numerous lifting devices 1 of different kinds may be in use. The inspector 14 may review the operating condition of each lifting device 1 at each site. However, the inspector 14 may review only some of the lifting devices 1 as requested by the user entity. By reviewing or inspecting lifting devices 1, it is meant that the inspector 14 may look over the length of the lifting device 1 to observe the condition of the lifting device 1 to determine the current operating condition of the lifting device 1. For example, a lifting strap 4, shown in FIG. 2, may be partially cut or burned. The inspector 14 may observe the defect and determine whether the lifting strap 4 can be used in its present state, repaired, or retired from use. It may be the case that the inspector 14, when attempting to locate a lifting device 1 to be inspected, cannot find the specific lifting device 1 that he intends to inspect. In such instance, he may report that the lifting device 1 is not available for inspection as will be discussed in a subsequent paragraph.

With continued reference to FIGS. 7 and 8, after the inspector 14 has inspected the lifting device 1, the inspector 14 may prepare an inspection report 19. The inspection report 19 may include descriptive information 21 about the lifting device 1, such as the type of lifting device, the size of the lifting device, the type of couplings that are on the lifting devices. Examples of descriptive information 21 may include but are not limited to the following: Alloy Chain, Nylon Strap, ½ Inch Grab Hook, ⅝ Inch Coupling Link and the like. Additionally, the report 19 may include any descriptive information 21 chosen with good judgment as is appropriate for an inspection report 19. The inspection report 19 may also include location information 23, which may refer to the particular storage area where this lifting device 1 is normally stored. The inspection report 19 may further include manufacturer information 25 such the manufacturer's name and serial number, as well as the year that the lifting device 1 was made. The inspection report 19 may also include details 28 from the inspection of the device 1. This may include comments stemming from the condition of the lifting device 1 relating to what defect was found, where the defect is located on the device and whether the lifting device 1 is suitable for continued use. It is noted at this point, that any information may be included on the inspection report 19 that is chosen with sound judgment.

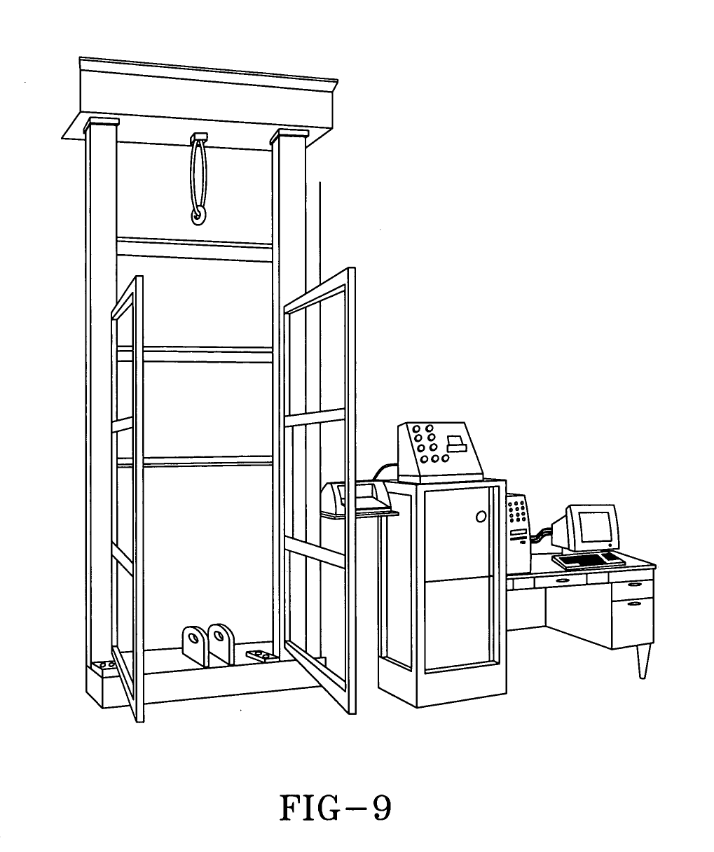

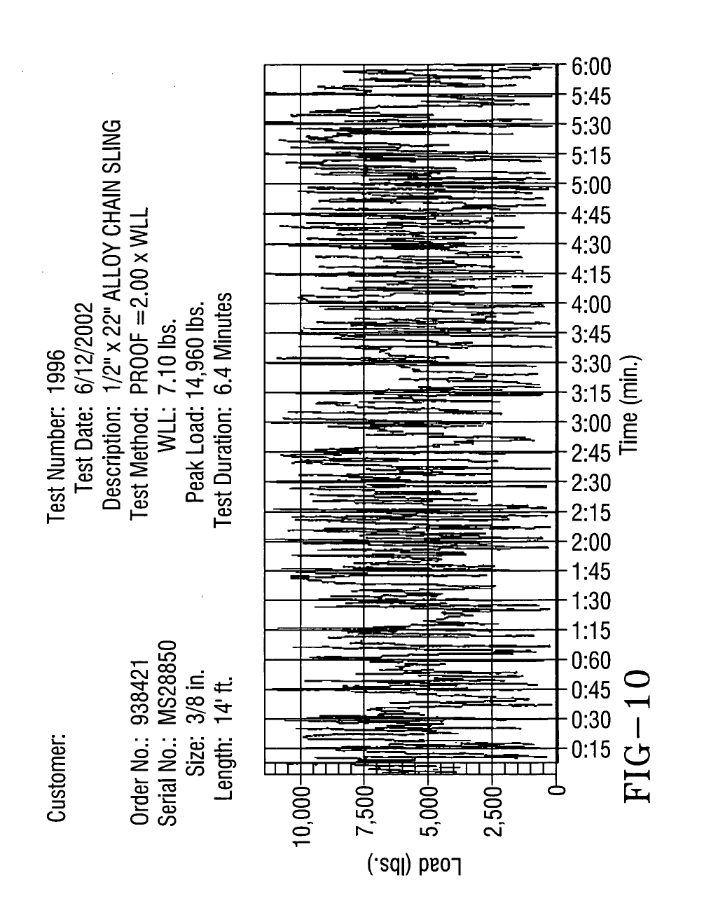

With reference now to FIGS. 9 and 10, the inspector 14 may also use a load testing machine to test lifting capacity of the lifting devices. The inspector 14 may place the lifting device 1 onto the load testing machine, shown in FIG. 9, and begin the testing process. The load testing machine may place a tension force of the lifting device 1 being. After the test has been completed, the inspector 14 may process the report, shown in FIG. 10, for review in a manner consistent with the present invention. In other words, the results of the test performed by the load testing machine may be available for review over a network or the internet, which will be discussed in greater detail in a subsequent paragraph.

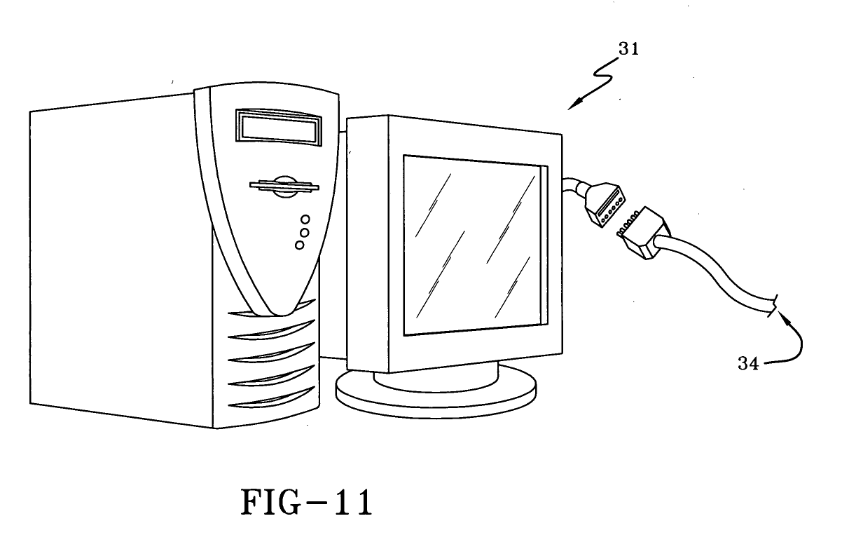

With reference to FIGS. 11 and through 15, when the inspection has been completed by the inspector 14, the inspector 14 may generate an inspection report 19 as previously mentioned. The inspector 14 may prepare a written or typed report identifying pertinent information about the lifting device 1, as discussed above. Alternately, the inspection report data may also be generated in electronic format. In other words, the inspector 14 may transfer test data stored in the load-testing machine to a computer upon returning to the home office. The data from the report 19 may be stored in a processing unit subsequent to the inspection process, which may be a computer, a load-testing machine or any other processing unit chosen with sound engineering judgment, the data may also be printed on a paper report in a manner well known in the art. However, it is noted that any manner of storing or maintaining the inspection report data may be chosen with sound engineering judgment. The data may then be transferred to another processing unit, which may be a microprocessing unit or computer 31, although any microprocessing unit capable of storing report data may be used to receive the report data. The computer 31 may be connected to a network, which may allow the computer 31 to display information to other remotely located computers as will be discussed further in a subsequent paragraph. In this manner, the data from the report 19 may be transferred electronically or typed into a keyboard that is communicated with the computer 31. The data may also be scanned in to the computer 31 via a scanner or other well-known mechanism for transferring data. In fact, any method or device may be used to transfer the data from the report into the computer 31 for use in viewing by a third party, as will be discussed in a subsequent paragraph.

With continued reference to FIG. 11, the microprocessing unit 31 may be connected to a network, such as the Internet 34 or a local area network 34 in a manner well known in the art. It is noted that the microprocessing unit 31 may be connected to any type of network that allows for client-server type applications. The microprocessing unit 31 may include a firewall and/or other security application software that selectively allows a remote user, which may be the user-entity, to access the microprocessing unit 31. In the preferred embodiment, the user-entity may be the primary user of the network communications link to the microprocessing unit 31. The user-entity may have access to a server computer or microprocessing unit 31 that is also connected to the aforementioned Internet 34 or local area network 34. As mentioned, the microprocessing unit 31 that receives the report data may include security software. The security software may selectively allow a remote user to access the host microprocessor unit via a user name and password. In this manner, the security software may verify a user's identity before allowing that user access to the system or to specific data. In the preferred embodiment, the security software allows a specific user-entity to access only information, which may be report data, that relates to that particular user-entity's lifting devices 1. In other words, when a first user-entity has their lifting devices 1 inspected, the inspector may transfer the report data to the host computer 31. The user-entity may then access the host computer 31 via the network with the predetermined user name and password. The security software may only display reports for the lifting devices located at the user-entity's site.

The security software operatively installed on the microprocessing unit 31 may be Internet or local area network security software such as is found in Windows NT. However, any type of selective user access security software may be chosen with sound engineering judgment. Additionally, the microprocessing unit 31 may include database software that may be used to receive the report data. In this manner, when the report data is transferred to the microprocessing unit 31, the report data may be transferred and stored in a database manager residing on the host microprocessor unit 31. Any type of database manager including but not limited to: SQL server or Microsoft Access, may be used to organize and selectively display the report data as chosen with sound engineering judgment. In this manner, the database manager may be used to selectively display information related only to that particular user-entity's lifting devices 1. Therefore, the database manager may also serve as a software security measure to selectively allow user access to the appropriate data. It is noted that the data organized by the database manager may be sorted and displayed for viewing or exported to link with other software applications including but not limited to Microsoft Excel or other spreadsheet. It is also noted that the report data may be e-mailed, faxed or electronically delivered to the user entity in any manner chosen with sound engineering judgment. In this way, the user-entity may log on to the network communicated with the microprocessing unit 31 that stores the report data and may display the specific reports related to that user-entity's lifting devices 1 or may choose to have the subject report data exported to the user-entity via e-mail, fax or printer. It is noted that one particular user-entity may not access another user-entity's inspection data without the permission of the that user-entity, who may provide the necessary user name and password to gain access to the data.

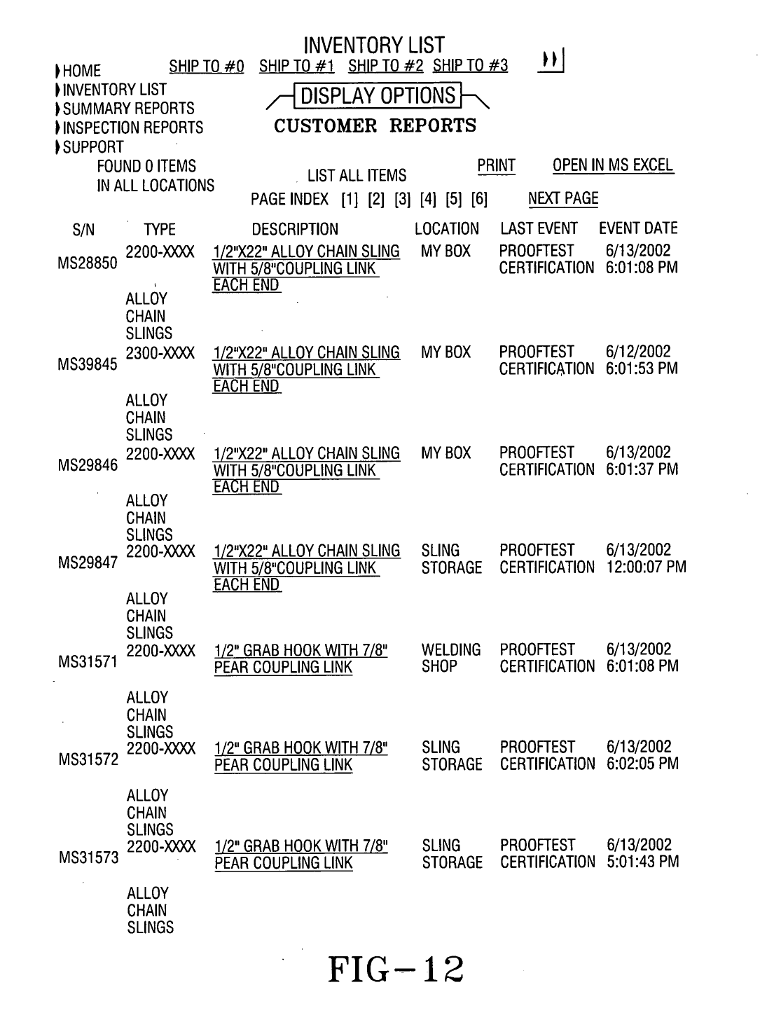

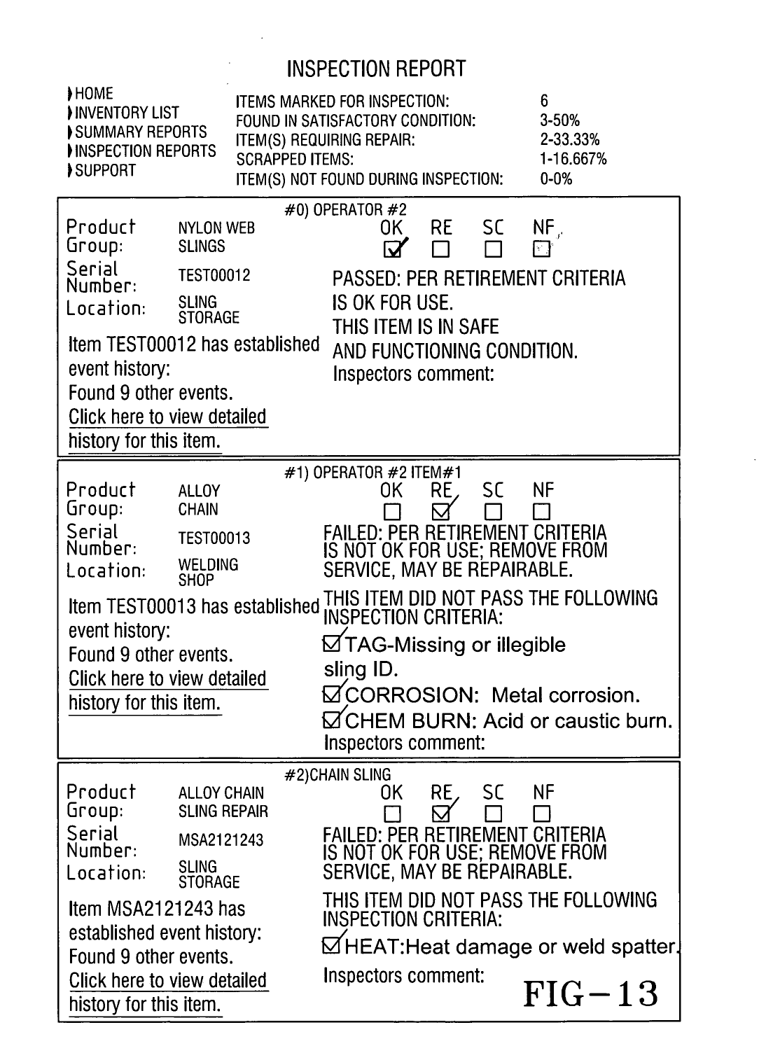

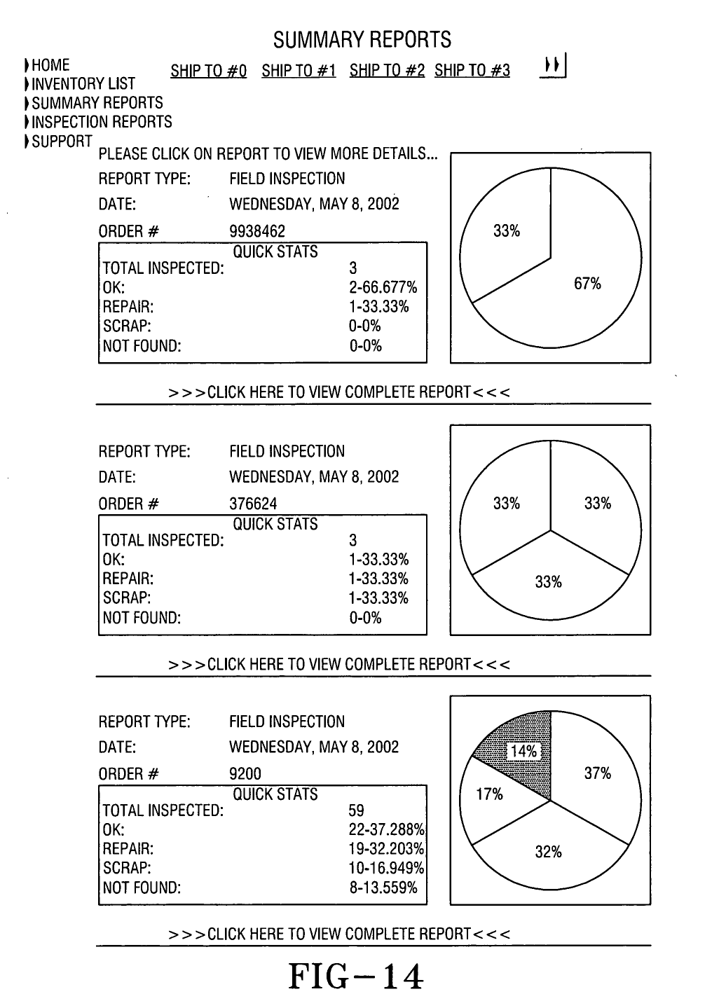

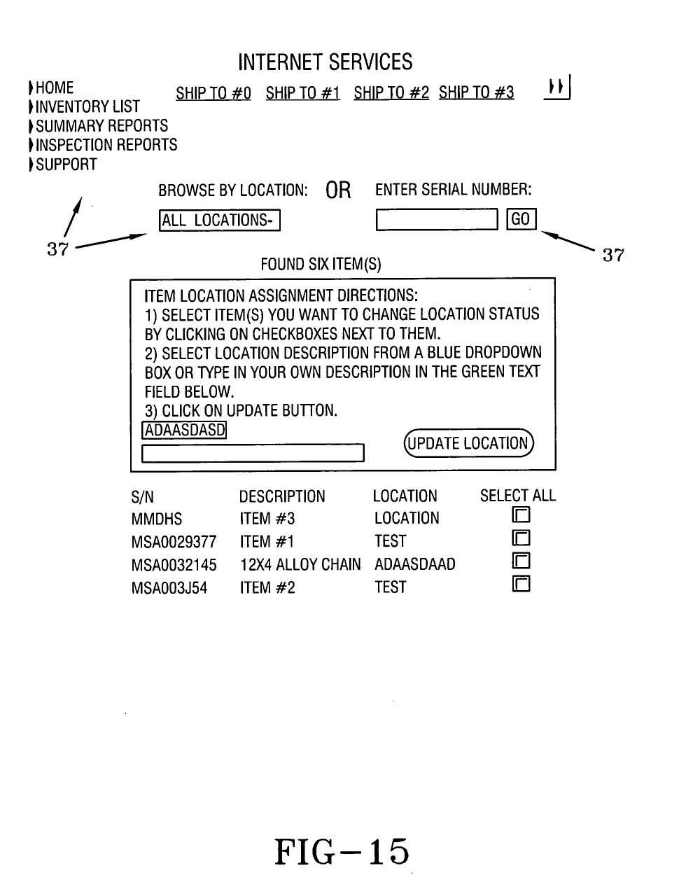

With reference now to FIGS. 12 through 15, the user-entity, after having gained access to the microprocessing unit's database manager software in a manner previously described, may selectively sort and view the report data for the lifting devices used at a particular site. The user-entity may choose from a plurality of options to view report data, including: an inventory list as shown in FIG. 12, inspection reports shown in FIG. 13 and summary reports shown in FIG. 14. It is expressly noted that any quantity or type of report formats may be used to selectively display report data as chosen with sound judgment. The user-entity may be prompted by an initial or home screen display 37, shown in FIG. 15, that allows the user-entity to select the type of report to be generated. Additionally, the screen display 37 may allow the user-entity to choose a location or site where certain lifting devices reside for which the user-entity desires to review inspection data. Still, the screen display 37 may allow the user-entity to select report data based upon serial number by prompting the user-entity for a specific serial number and/or manufacturer's name. However, it is noted that any manner of selectively allowing a verified user-entity to display, export and review inspection data may be chosen with sound judgment. Subsequently, the verified or logged-on user-entity may link to any other format of report as provided by the database manager software.

The summary report, reference FIG. 14, may include summary data about a group of lifting devices 1. The group of lifting devices 1 may be grouped by location, type or any other characteristic. The summary report may include a pie chart depicting the quantity of lifting devices 1 that passed or failed the inspection report. However, any manner of depicting the summary information may be chosen with sound judgment. Additionally, it is understood that any summary information may be depicted in the summary report that is chosen with sound judgment.

With reference to FIG. 12, the inventory list may include a listing of lifting devices 1 owned or used by the user-entity. The inventory list may display data related to serial number, description, inspection results, inspection date, and the like. The inventory list may display multiple listings on a single display page or screen.

With reference to all of the FIGURES, the method of the present invention is described as follows. A lifting device inspector may travel to the site where one or more lifting devices are used to lift and support heavy objects. The inspector may inspect all of the lifting devices at that particular site. The inspector may inspect the lifting devices to determine the lifting condition of the lifting devices. That is to say, the inspector may inspect the lifting devices to determine whether a particular lifting device requires repair, is approved for use, must be retired from use and the like. The inspector may test the actual load capacity of the lifting devices. Subsequently, the inspector may generate an inspection report listing the related details about the inspection and/or test of the lifting devices. The inspection report data may then be transferred to a host computer wherein the computer is operatively communicated to the Internet or other network. The computer may include security and other software to selectively allow a predetermined user access to the report data. The computer may also include software to selectively sort and display the report data in a data format as described above. The user of the lifting devices or other authorized user-entity may log onto the computer with a predetermined password. The user may then gain access to the report data pertaining to the lifting devices associated with that particular user-entity. In other words, the logged-on user-entity may not gain access to other data not associated with the lifting devices of that user-entity. The verified or properly logged-on user entity may then select from a variety of formats to display the lifting device inspection report data, including: printing out of the report data, transferring the data to a spreadsheet or other software means for analyzing data or just viewing the data on the display screen of a computer, or other microprocessing means, used to communicate with the host computer.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A method for viewing inspection reports for an associated lifting device, the method comprising:
providing an associated periodic inspection of the associated lifting device by an associated inspector;
providing at least a first inspection report generated in response to the associated inspection;
providing a computer operatively communicated to an associated computer network;
operatively storing at least a first portion of the at least a first inspection report on the computer, wherein the at least a first portion of the at least a first inspection report is viewable over the associated computer network; and,
implementing a security means on the computer for use in selectively allowing an associated user-entity to view the at least a first portion of at least a first inspection report over the associated computer network.

2. The method of claim 1, wherein the associated lifting device has an associated lifting strap, and an associated lifting chain.

3. The method of claim 2, wherein the step of operatively storing at least a first portion of the at least a first inspection report on the computer includes:
operatively storing an inventory list of the at least a first portion of the at least a first inspection report on the computer, wherein the inventory list is viewable over the computer network.

4. The method of claim 2, wherein the step of operatively storing at least a first portion of the at least a first inspection report on the computer includes:
operatively storing a summary list of the at least a first portion of the at least a first inspection report on the computer, wherein the summary list is viewable over the computer network.

5. The method of claim 1, wherein the step of operatively storing at least a first portion of the at least a first inspection report on the computer, includes:
storing at least a first portion of the at least a first inspection report in a database, wherein the database is operatively accessible by the computer.

6. The method of claim 5, wherein the step of storing at least a first portion of the at least a first inspection report in a database, wherein the database is operatively accessible by the computer, includes:
storing at least a first portion of the at least a first inspection report in a database, wherein the database is operatively stored on the computer.

7. The method of claim 5, wherein after the step of storing at least a first portion of the at least a first inspection report in a database, wherein the database is operatively accessible by the computer, the step further comprising:
selectively sorting the database, wherein the sorted at least a first portion of the at least a first inspection report is selectively viewable over the computer network.

8. The method of claim 7, wherein the step of providing at least a first inspection report generated in response to the associated inspection, includes:
providing a plurality of inspection reports generated in response to a plurality of associated inspections, and;
wherein the step of selectively sorting the database, includes:
selectively sorting the database with respect to the history of the plurality of inspection reports, wherein the sorted at least a first portion of the plurality of inspection reports is selectively viewable over the computer network.

9. A method for periodically testing, and viewing the testing report, for an associated lifting strap, the steps comprising:
providing an associated lifting strap testing device for testing the lifting capacity of the associated lifting strap, the associated testing device including associated software for use in processing test data;
providing a testing person qualified to operate the associated testing device;
performing the lifting capacity test on the associated lifting strap;
generating a test report responsive to an output from the associated testing device;
providing a computer operatively communicated to an associated computer network; and,
storing at least a first portion of the electronic test report on the computer, wherein the at least a first portion of the test report is viewable over the associated computer network.

10. The method of claim 9, wherein the step of generating a test report responsive to an output from the associated testing device, includes:
generating an electronic test report responsive to an output from the associated testing device.

11. A method of tracking the testing history for a plurality of associated lifting devices, the steps comprising:
providing a plurality of associated lifting devices for use by an associated user-entity;
periodically individually testing the plurality of associated lifting devices;
generating a testing report responsive to each individual test;
providing a computer operatively communicated to an associated computer network; and,
storing the testing reports on the computer, wherein the plurality of testing reports are selectively viewable by the user-entity.

12. The method of claim 11, wherein the step of providing a plurality of associated lifting devices includes:
providing a plurality of associated lifting straps for use by an associated user-entity.

13. The method of claim 11, wherein the step of periodically individually testing the plurality of associated lifting devices, includes:
periodically testing the current lifting capacity of the plurality of associated lifting devices.

14. The method of claim 13, wherein before the step of periodically testing the current lifting capacity of the plurality of associated lifting devices, the step further comprising:
providing an associated lifting capacity testing apparatus having associated software that electronically stores testing information responsive to the testing.

15. The method of claim 12, wherein the step of providing a computer operatively communicated to an associated computer network, includes:
providing a microprocessor-based computer operatively communicated to the internet.

16. The method of claim 1 1, the step further comprising:
sorting the testing reports with respect to the testing date.
